(19) United States
(12) Patent Application Publication
(10) Pub. No.: US 2020/0308444 A1
(43) Pub. Date: Oct. 1, 2020

(54) PAINT POLISH SEALANT COMPOSITION AND METHODS OF PREPARATION THEREOF

(71) Applicant: G. GRIPP'S, LLC, Houston, TX (US)

(72) Inventor: Greg Gripp, Houston, TX (US)

(73) Assignee: G. GRIPP'S, LLC, Houston, TX (US)

(21) Appl. No.: 16/817,186

(22) Filed: Mar. 12, 2020

Related U.S. Application Data
(60) Provisional application No. 62/823,709, filed on Mar. 26, 2019.

(51) Int. Cl. C09D 191/06; C09D 183/08; C09D 127/12; C09D 7/61

(52) U.S. Cl. CPC C09D 191/06; C09D 7/61; C09D 127/12; C09D 183/08

(57) ABSTRACT

A paint polish sealant composition is disclosed herein, as well as processes for preparing the same. A benefit to the paint polish sealant composition can be providing a protective treatment having superior shine and durability for a painted surface.

### CROSS-REFERENCE TO RELATED APPLICATIONS

This application claims the benefit of U.S. Provisional Application No. 62/823,709, which was filed on Mar. 26, 2019, the entire contents of which is hereby incorporated by reference herein.

### TECHNICAL FIELD

A paint polish sealant composition is disclosed herein, as well as processes for preparing the same. A benefit to the paint polish sealant composition can be providing a protective treatment having superior shine and durability for a painted surface.

### BACKGROUND

Polish sealants are widely used as protective treatments to polish and seal painted surfaces. Several components are used in the preparation of polish sealants, including cleaners, abrasive compounds, sealant compounds, and waxes, that can impart painted surfaces with desired qualities, such as shine and durability. Various types of vehicles, including automobiles, have painted surfaces to which polish sealants can be applied.

### SUMMARY

Embodiments herein are directed to paint polish sealants and processes for preparing the same. Other embodiments are directed to kits for polishing a painted surface.

In an aspect, a process for preparing a paint polish sealant composition comprises providing a first aqueous mixture, wherein the first aqueous mixture includes a first natural wax, at least two first polymer resins, and a silica solid; providing a second aqueous mixture, wherein the second aqueous mixture includes a second natural wax, a polymer wax, and at least two second polymer resins; providing a third aqueous mixture, wherein the third aqueous mixture includes at least two amino group bearing silicone resins, an aluminum silicate clay, and a cleaning agent; and combining the first aqueous mixture, the second aqueous mixture, and the third aqueous mixture to prepare the paint polish sealant composition.

In certain embodiments, the paint polish sealant composition includes from about 20% to about 40% by volume of the first aqueous mixture; from about 20% to about 40% by volume of the second aqueous mixture; and from about 20% to about 40% by volume of the third aqueous mixture, based on a total volume of the paint polish sealant composition. In certain embodiments, the paint polish sealant composition includes from about 30% to about 36% by volume of the first aqueous mixture; from about 30% to about 36% by volume of the second aqueous mixture; and from about 30% to about 36% by volume of the third aqueous mixture, based on a total volume of the paint polish sealant composition. In certain embodiments, the paint polish sealant composition includes from about 25% to about 30% by volume of the first aqueous mixture; from about 25% to about 30% by volume of the second aqueous mixture; and from about 25% to about 30% by volume of the third aqueous mixture, based on a total volume of the paint polish sealant composition. In certain embodiments, the composition includes from about 35% to about 40% by volume of the first aqueous mixture; from about 35% to about 40% by volume of the second aqueous mixture; and from about 35% to about 40% by volume of the third aqueous mixture, based on a total volume of the paint polish sealant composition.

In certain embodiments, the third aqueous mixture further includes a synthetic fluoropolymer. In an embodiment, the third aqueous mixture excludes wax.

In certain embodiments, the silica solid includes one or more of diatomaceous earth, diatomite, and cristobalite.

In certain embodiments, the first aqueous mixture further comprises a siloxane polymer or dimethylpolysiloxane polymer.

In certain embodiments, at least one of the first natural wax and the second natural wax is a Carnauba wax. In certain embodiments, the aluminum silicate clay is a Kaolin clay.

In certain embodiments, at least one of the first aqueous mixture, the second aqueous mixture, and the third aqueous mixture includes an emulsifier.

In certain embodiments, the at least two amino group bearing silicone resins are capable of curing together to form a sealant on a painted surface.

In embodiments, a paint polish sealant composition prepared by the processes described above is disclosed.

In an aspect, a paint polish sealant composition prepared by an embodied process is provided. In an embodiment, the paint polish sealant composition is prepared by a process including providing a first aqueous mixture, wherein the first aqueous mixture includes a first natural wax, at least two first polymer resins, and a silica solid; providing a second aqueous mixture, wherein the second aqueous mixture includes a second natural wax, a polymer wax, and at least two second polymer resins; providing a third aqueous mixture, wherein the third aqueous mixture includes at least two amino group bearing silicone resins, an aluminum silicate clay, and a cleaning agent; and forming a paint polish sealant composition by combining the first aqueous mixture, the second aqueous mixture, and the third aqueous mixture, wherein the third aqueous mixture excludes wax.

In certain embodiments, the composition includes from about 20% to about 40% by volume of the first aqueous mixture; from about 20% to about 40% by volume of the second aqueous mixture; and from about 20% to about 40% by volume of the third aqueous mixture, based on a total volume of the paint polish sealant composition. In certain embodiments, the composition includes from about 30% to about 36% by volume of the first aqueous mixture; from about 30% to about 36% by volume of the second aqueous mixture; and from about 30% to about 36% by volume of the third aqueous mixture, based on a total volume of the paint polish sealant composition. In certain embodiments, the composition includes from about 25% to about 30% by volume of the first aqueous mixture; from about 25% to about 30% by volume of the second aqueous mixture; and from about 25% to about 30% by volume of the third aqueous mixture, based on a total volume of the paint polish sealant composition. In certain embodiments, the composition includes from about 35% to about 40% by volume of the first aqueous mixture; from about 35% to about 40% by volume of the second aqueous mixture; and from about 35% to about 40% by volume of the third aqueous mixture, based on a total volume of the paint polish sealant composition. In an embodiment, the at least two amino group bearing silicone resins are capable of curing together to form a sealant on a painted surface.

In an aspect, a kit for polishing a painted surface is provided, including at least 2 of: a first vessel containing a first aqueous mixture, wherein the first aqueous mixture includes a first natural wax, at least two first polymer resins, and a silica solid; a second vessel containing a second aqueous mixture, wherein the second aqueous mixture includes a second natural wax, a polymer wax, and at least two second polymer resins; and a third vessel containing a third aqueous mixture, wherein the third aqueous mixture includes at least two amino group bearing silicone resins, an aluminum silicate clay, and a cleaning agent.

In an embodiment, the third aqueous mixture excludes wax.

### DETAILED DESCRIPTION

Unless otherwise noted, all measurements are in standard metric units.

Unless otherwise noted, all instances of the words “a,” “an,” or “the” can refer to one or more than one of the word that they modify.

Unless otherwise noted, the phrase “at least one of” means one or more than one of an object. For example, “at least one of a first aqueous mixture, a second aqueous mixture, and a third aqueous mixture” means a first aqueous mixture, a second aqueous mixture, a third aqueous mixture, or any combination thereof.

The term “about” as applied to measurements is a term of approximation and that varies depending on its context. Unless otherwise noted, the term “about” refers to ±10% of the non-percentage number that is described, rounded to the nearest whole integer. For example, about 100 mm, can include 90 to 110 mm. Unless otherwise noted, the term “about” refers to ±2% of a percentage number. For example, about 20% can include 18 to 22%. When the term “about” is discussed in terms of a range, then the term refers to the appropriate amount less than the lower limit and more than the upper limit. For example, from about 25% to about 30% can include from 23% to 32%.

Unless otherwise noted, properties (height, width, length, ratio etc.) as described herein are understood to be averaged measurements.

Performance properties of polishing and sealant products used to treat painted surfaces include the capability to polish or clean the surface, the amount or character of gloss or shine imparted to the surface, and the durability of the finish on the treated surface. The types of components used, and their relative proportions in such products, can determine product performance. Increasing an amount of one component relative to another may enhance a particular property of that component to the detriment of another, often in unexpected ways. For example, if polishing capability is emphasized, the shine or gloss achieved may suffer. Conventional paint polish and sealant products do not provide cleaning, polishing, and sealing properties at desired performance levels, and it has been found that many polishing solutions are not as durable as their manufacturers boast.

It has been surprisingly discovered that a commercially available wax, a polish, and a polymer can be mixed together to form the polish sealant composition of the present disclosure to provide superior shine and durability to any of the three components individually. People have argued that a commercially available wax cannot be mixed with a polish because it would be like mixing oil and water. Most, if not all, commercial waxes and polishes warn users not to apply them in direct sunlight or blemishes will occur. However, it has been discovered that when these three commercially available products are combined, then the polish sealant composition of the present disclosure can be applied in direct sunlight at heat indexes from 105° F. to 110° F. without any blemishes. Without wishing to be bound by theory, it is believed that applying the polish sealant composition of the present disclosure with friction and/or heat causes the underlying components to mix together on the painted surface they are being applied to. Further, without wishing to be bound by theory, it is believed that when these components are combined that applying the polish sealant composition of the present disclosure with friction and/or heat causes the polymers, often present as polymer spheres, to unravel and better coat the surface to provide for a superior shine and/or increased durability.

Embodiments of the present disclosure can provide a polish sealant composition having superior polishing and sealing properties. Embodiments herein can provide an advantage of a polish sealant composition having superior polishing and sealing performance properties in a single composition.

Although embodiments of the polish sealant are designed for use on painted surfaces of vehicles, such as cars, trucks, recreational vehicles, boats, and aircraft, a person of skill in the art will recognize that embodiments of the polish sealant composition could also be used on any compatible painted surface. Such painted surfaces can include surfaces painted with any automotive paint, such as lacquer-based paints and finishes including acrylic lacquer, enamel paints including acrylic enamels, urethane paints, clear coat finishes, and gel coat finishes.

Embodiments are directed to a paint polish sealant composition and processes for preparing the same. Other embodiments are directed to kits for polishing a painted surface.

### Processes and Aqueous Mixtures of Various Embodiments

In an embodiment, a process for preparing a paint polish sealant composition includes providing a first aqueous mixture, a second aqueous mixture, and a third aqueous mixture, and combining the first aqueous mixture, the second aqueous mixture, and the third aqueous mixture to form a paint polish sealant composition. In an embodiment, the first aqueous mixture includes or consists of P-57 MIRACLE WAX™ Cream. In an embodiment, the second aqueous mixture includes or consists of P&S ULTRACOAT™ Polish. In an embodiment, the third aqueous mixture includes or consists of P-39 POLYMER II™.

In an embodiment of such a process, the first aqueous mixture includes a first natural wax, at least two first polymer resins, and a silica solid. In an embodiment, the second aqueous mixture includes a second natural wax, a polymer wax, and at least two second polymer resins. In an embodiment, the third aqueous mixture includes at least two amino group bearing silicone resins, an aluminum silicate clay, and a cleaning agent.

Embodied aqueous mixtures can include a first natural wax and a second natural wax. Such a natural wax can include a vegetable wax such as a Carnauba wax, or an animal wax such as beeswax. Embodied aqueous mixtures can include a polymer wax. Such a polymer wax can include a petroleum wax, such as a paraffin wax; a microcrystalline wax, such as a synthetic carnauba wax; a mineral fossil wax, such as a Montan wax; or a synthetic wax, such as an ethylene polymer wax, or a silicone wax. Benefits of a natural wax or a polymer wax for a paint sealant composition can include providing protective coating, sealing and emulsification properties, and providing shine or gloss to a painted surface.

Embodied aqueous mixtures can include at least two first polymer resins and at least two second polymer resins. In such embodiments, the at least two first polymer resins can be the same or different from the at least two second polymer resins. Embodied polymer resins can include one or more of a silicone resin and a silicone fluid. Such embodiments can include one or more of a siloxane polymer, a dimethylpolysiloxane polymer, and a polydimethylsiloxane polymer. Other embodied polymer resins can include one or more amino group bearing silicone resins. Benefits of a polymer resin can include providing durable sealing properties to a paint polish sealant composition, and providing shine or gloss to a polished painted surface.

Embodiments of the third aqueous mixture include at least two amino group bearing silicone resins. In certain embodiments, the at least two amino group bearing silicone resins are capable of curing together to form a sealant on a painted surface. In such embodiments, one or more accelerators can be included to increase the rate of curing together of the at least two amino group bearing silicone resins. A benefit of an amino group bearing silicone resin can include bonding to paint on a painted surface, thereby providing durable sealing properties to a paint polish sealant composition.

Embodied aqueous mixtures can include a silica solid. Such a silica solid can include one or more of diatomaceous earth, diatomite, cristobalite, or another silica based abrasive particle. Embodied aqueous mixtures can include an aluminum oxide. In such embodiments, an aluminum oxide can be combined with a silica solid. Embodied aqueous mixtures can include an aluminum silicate clay. Such an aluminum silicate clay can include a Kaolin clay. Benefits of a silica solid or aluminum oxide can include providing polishing and cleaning properties to a paint polish sealant composition.

Embodied aqueous mixtures can include a cleaning agent. Such a cleaning agent can include one or more of a detergent, a surfactant, or a solid particle, such as an abrasive particle, including a silica solid or an aluminum oxide. A benefit of a cleaning agent can include providing paint surface cleaning properties to a paint polish sealant composition.

In certain embodiments, the third aqueous mixture includes a fluoropolymer. Such a fluoropolymer can include a synthetic fluoropolymer, such as polytetrafluoroethylene. A benefit of a fluoropolymer can include reducing friction buildup on a painted surface, so that contaminants are less likely to adhere to the surface.

In certain embodiments, the third aqueous mixture excludes wax.

In certain embodiments, at least one of the first aqueous mixture, the second aqueous mixture, and the third aqueous mixture includes an emulsifier. Such an emulsifier can include one or more of a surfactant, a fatty acid, a silicone emulsifier, or a wax. A benefit of an emulsifier can include providing suspension, solubility and stability to components of a paint polish sealant composition.

Various embodiments of the first aqueous mixture, the second aqueous mixture, and the third aqueous mixture include water as a solvent. In other embodiments, one or more additional solvents are included in such embodiments, and can include one or more volatile organic compound solvents. A benefit of a solvent can include providing solubility to components of a paint polish sealant composition.

### Compositions of Various Embodiments

An embodiment provides a paint polish sealant composition prepared by an embodied process. Such an embodied process includes providing a first aqueous mixture, a second aqueous mixture, and a third aqueous mixture, and combining the first aqueous mixture, the second aqueous mixture, and the third aqueous mixture to form a paint polish sealant composition.

Various proportions of the first aqueous mixture, the second aqueous mixture, and the third aqueous mixture in embodied polish sealant compositions are possible. In an embodiment, the paint polish sealant composition includes from about 20% to about 40% by volume of the first aqueous mixture, based on a total volume of the paint polish sealant composition. In an embodiment, the paint polish sealant composition includes from about 20% to about 40% by volume of the second aqueous mixture, based on a total volume of the paint polish sealant composition. In an embodiment, the paint polish sealant composition includes from about 20% to about 40% by volume of the third aqueous mixture, based on a total volume of the paint polish sealant composition, based on a total volume of the paint polish sealant composition.

In an embodiment, the paint polish sealant composition includes from about 30% to about 36% by volume of the first aqueous mixture, based on a total volume of the paint polish sealant composition. In an embodiment, the paint polish sealant composition includes from about 30% to about 36% by volume of the second aqueous mixture, based on a total volume of the paint polish sealant composition. In an embodiment, the paint polish sealant composition includes from about 30% to about 36% by volume of the third aqueous mixture, based on a total volume of the paint polish sealant composition.

In an embodiment, the paint polish sealant composition includes from about 25% to about 30% by volume of the first aqueous mixture, based on a total volume of the paint polish sealant composition. In an embodiment, the paint polish sealant composition includes from about 25% to about 30% by volume of the second aqueous mixture, based on a total volume of the paint polish sealant composition. In an embodiment, the paint polish sealant composition includes from about 25% to about 30% by volume of the third aqueous mixture, based on a total volume of the paint polish sealant composition.

In an embodiment, the paint polish sealant composition includes from about 35% to about 40% by volume of the first aqueous mixture, based on a total volume of the paint polish sealant composition. In an embodiment, the paint polish sealant composition includes from about 35% to about 40% by volume of the second aqueous mixture, based on a total volume of the paint polish sealant composition. In an embodiment, the paint polish sealant composition includes from about 35% to about 40% by volume of the third aqueous mixture, based on a total volume of the paint polish sealant composition.

In an embodiment, the processing forming a paint polish sealant composition by combining the first aqueous mixture, the second aqueous mixture, and the third aqueous mixture can include mixing the aqueous mixtures by hand or using a commercial mixer or shaker. In an embodiment, the process of forming a paint polish sealant composition can include heating at least one of the first aqueous mixture, the second aqueous mixture, and the third aqueous mixture, or components thereof, before, during, or after combination.

### Kits of Various Embodiments

In an aspect, a kit for polishing a painted surface comprises at least 2 of: a first vessel containing a first aqueous mixture, wherein the first aqueous mixture includes a first natural wax, at least two first polymer resins, and a silica solid; a second vessel containing a second aqueous mixture, wherein the second aqueous mixture includes a second natural wax, a polymer wax, and at least two second polymer resins; and a third vessel containing a third aqueous mixture, wherein the third aqueous mixture includes at least two amino group bearing silicone resins, an aluminum silicate clay, and a cleaning agent. In an embodiment, the third aqueous mixture excludes wax.

In an embodiment, the kit can include a first vessel containing a first aqueous mixture, a second vessel containing a second aqueous mixture, and a third vessel containing a third aqueous mixture. In such an embodiment, a user of the kit can form a polish sealant composition for polishing a painted surface by combining the first aqueous mixture, the second aqueous mixture, and the third aqueous mixture.

An embodied kit can include any two of a first vessel containing a first aqueous mixture, a second vessel containing a second aqueous mixture, and a third vessel containing a third aqueous mixture. In such embodiments, a paint polish sealant composition can be formed by a user of the kit, by providing an aqueous mixture according to embodiments herein and combining the aqueous mixture with the two aqueous mixtures included in the kit.

In an embodiment, the kit can include a first vessel containing a first aqueous mixture and a second vessel containing a fourth aqueous mixture, wherein the forth aqueous mixture is a mixture of the second and third aqueous mixtures. In an embodiment, the kit can include a first vessel containing the second aqueous mixture and a second vessel containing a fifth aqueous mixture, wherein the fifth aqueous mixture is a mixture of the first and third aqueous mixtures. In an embodiment, the kit can include a first vessel containing the third aqueous mixture and a second vessel containing a sixth aqueous mixture, wherein the sixth aqueous mixture is a mixture of the first and second aqueous mixtures.

### EXAMPLES

### Example #1

### Paint Polish Sealant Preparation

This example illustrates the preparation of a paint polish sealant according to the embodiments described herein. A paint polish sealant composition can be prepared by mixing equal volumes of a first aqueous mixture, a second aqueous mixture, and a third aqueous mixture together in a paint shaker. In this example, P-57 MIRACLE WAX™ Cream (BAF Industries, 1451 Edinger Avenue, Suite F, Tustin, Calif. 92780) can be the first aqueous mixture; P&S ULTRACOAT™ Polish Stock #B2001 (P&S Sales, Inc., 20943 Cabot Blvd., Hayward, Calif. 94545-1155) can be used as the second aqueous mixture; and P-39 POLYMER II™ (BAF Industries, 1451 Edinger Avenue, Suite F, Tustin, Calif. 92780) can be used as the third aqueous mixture. The paint polish sealant composition can be applied to a painted surface within an hour.

### Example #2

### Paint Polish Sealant Preparation

This example illustrates the preparation of a paint polish sealant according to embodiments described herein. A composition of the paint polish sealant can be prepared by mixing equal volumes of a first aqueous mixture, a second aqueous mixture, and a third aqueous mixture together in a chemical mixer, followed by further mixing in a paint shaker. In this example, P-57 MIRACLE WAX™ Cream (BAF Industries, 1451 Edinger Avenue, Suite F, Tustin, Calif. 92780) can be used as the first aqueous mixture; P&S ULTRACOAT™ Polish Stock #B2001 (P&S Sales, Inc., 20943 Cabot Blvd., Hayward, Calif. 945-1155) can be used as the second aqueous mixture; and P-39 POLYMER II™ (BAF Industries,1451 Edinger Avenue, Suite F, Tustin, Calif. 92780) can be used as the third aqueous mixture. The paint polish sealant can have a desired creamy consistency. In this example, a paint polish sealant of high quality can be formulated by hand. The paint polish sealant composition can be applied by either hand or orbital buffer within an hour and can begin being removed with ease within five minutes after its application. When applied to a painted surface, the paint polish sealant can provide an easy on and easy off, 3-in-1 cleaning, polishing and sealing process. The paint polish sealant can deep clean, polish (including the removal of surface scratches) and protect a painted surface. The paint polish sealant can produce a high gloss finish, lustrous color depth, and lasting protection for a painted surface for up to six months, with minimal effort.

What is claimed is:

1. A process for preparing a paint polish sealant composition comprising:
providing a first aqueous mixture, wherein the first aqueous mixture includes a first natural wax, at least two first polymer resins, and a silica solid;
providing a second aqueous mixture, wherein the second aqueous mixture includes a second natural wax, a polymer wax, and at least two second polymer resins;
providing a third aqueous mixture, wherein the third aqueous mixture includes at least two amino group bearing silicone resins, an aluminum silicate clay, and a cleaning agent; and
combining the first aqueous mixture, the second aqueous mixture, and the third aqueous mixture to prepare the paint polish sealant composition.

2. The process of claim 1, wherein the paint polish sealant composition includes
from about 20% to about 40% by volume of the first aqueous mixture;
from about 20% to about 40% by volume of the second aqueous mixture; and
from about 20% to about 40% by volume of the third aqueous mixture, based on a total volume of the paint polish sealant composition.

3. The process of claim 1, wherein the paint polish sealant composition includes
from about 30% to about 36% by volume of the first aqueous mixture;
from about 30% to about 36% by volume of the second aqueous mixture; and
from about 30% to about 36% by volume of the third aqueous mixture, based on a total volume of the paint polish sealant composition.

4. The process of claim 1, wherein the paint polish sealant composition includes
from about 25% to about 30% by volume of the first aqueous mixture;
from about 25% to about 30% by volume of the second aqueous mixture; and
from about 25% to about 30% by volume of the third aqueous mixture, based on a total volume of the paint polish sealant composition.

5. The process of claim 1, wherein the composition includes
from about 35% to about 40% by volume of the first aqueous mixture;
from about 35% to about 40% by volume of the second aqueous mixture; and
from about 35% to about 40% by volume of the third aqueous mixture, based on a total volume of the paint polish sealant composition

6. The process of claim 1, wherein the third aqueous mixture includes a synthetic fluoropolymer and the third aqueous mixture excludes wax.

7. The process of claim 1, wherein the silica solid is selected from the group consisting of diatomaceous earth, diatomite, and cristobalite.

8. The process of claim 1, wherein the first aqueous mixture further comprises:
dimethylpolysiloxane polymer or a siloxane polymer.

9. The process of claim 1, wherein at least one of the first natural wax and the second natural wax is a Carnauba wax, or the aluminum silicate clay is a Kaolin clay.

10. The process of claim 1, wherein at least one of the first aqueous mixture, the second aqueous mixture, and the third aqueous mixture includes an emulsifier.

11. The process of claim 1, wherein the at least two amino group bearing silicone resins are capable of curing together to form a sealant on a painted surface.

12. A paint polish sealant composition prepared by the process of claim 1.

13. A paint polish sealant composition prepared by a process comprising:
providing a first aqueous mixture, wherein the first aqueous mixture includes a first natural wax, at least two first polymer resins, and a silica solid;
providing a second aqueous mixture, wherein the second aqueous mixture includes a second natural wax, a polymer wax, and at least two second polymer resins;
providing a third aqueous mixture, wherein the third aqueous mixture includes at least two amino group bearing silicone resins, an aluminum silicate clay, and a cleaning agent; and
forming a paint polish sealant composition by combining the first aqueous mixture, the second aqueous mixture, and the third aqueous mixture,
wherein the third aqueous mixture excludes wax.

14. The composition of claim 13, wherein the composition includes
from about 20% to about 40% by volume of the first aqueous mixture;
from about 20% to about 40% by volume of the second aqueous mixture; and
from about 20% to about 40% by volume of the third aqueous mixture, based on a total volume of the paint polish sealant composition.

15. The composition of claim 13, wherein the composition includes
from about 30% to about 36% by volume of the first aqueous mixture;
from about 30% to about 36% by volume of the second aqueous mixture; and
from about 30% to about 36% by volume of the third aqueous mixture, based on a total volume of the paint polish sealant composition.

16. The composition of claim 13, wherein the composition includes
from about 25% to about 30% by volume of the first aqueous mixture;
from about 25% to about 30% by volume of the second aqueous mixture; and
from about 25% to about 30% by volume of the third aqueous mixture, based on a total volume of the paint polish sealant composition.

17. The composition of claim 13, wherein the composition includes
from about 35% to about 40% by volume of the first aqueous mixture;
from about 35% to about 40% by volume of the second aqueous mixture; and
from about 35% to about 40% by volume of the third aqueous mixture, based on a total volume of the paint polish sealant composition.

18. The composition of claim 13, wherein the at least two amino group bearing silicone resins are capable of curing together to form a sealant on a painted surface.

19. A kit for polishing a painted surface, comprising at least 2 of:
a first vessel containing a first aqueous mixture, wherein the first aqueous mixture includes a first natural wax, at least two first polymer resins, and a silica solid;
a second vessel containing a second aqueous mixture, wherein the second aqueous mixture includes a second natural wax, a polymer wax, and at least two second polymer resins; and
a third vessel containing a third aqueous mixture, wherein the third aqueous mixture includes at least two amino group bearing silicone resins, an aluminum silicate clay, and a cleaning agent.

20. The kit of claim 19, wherein the third aqueous mixture excludes wax.
